(19) United States
(12) Patent Application Publication
(10) Pub. No.: US 2026/0088301 A1
(43) Pub. Date: Mar. 26, 2026

(54) ELECTRODE, BATTERY, AND METHOD OF PRODUCING ELECTRODE

(71) Applicant: TOYOTA JIDOSHA KABUSHIKI KAISHA, Toyota-shi (JP)

(72) Inventors: Daichi KOSAKA, Toyota-shi (JP); Tatsuya EGUCHI, Kariya-shi (JP); Takeshi KIMIJIMA, Kariya-shi (JP)

(73) Assignee: TOYOTA JIDOSHA KABUSHIKI KAISHA, Toyota-shi (JP)

(21) Appl. No.: 19/322,973

(22) Filed: Sep. 9, 2025

(30) Foreign Application Priority Data
Sep. 20, 2024 (JP) 2024-163314

(51) Int. Cl. H01M 4/62; H01M 4/02; H01M 4/04; H01M 4/58

(52) U.S. Cl. CPC H01M 4/628; H01M 4/0404; H01M 4/5825; H01M 2004/021; H01M 2004/029

(57) ABSTRACT

An electrode comprising a current-collecting foil sheet and a positive electrode layer, wherein the positive electrode layer is placed on a surface of the current-collecting foil sheet, the positive electrode layer includes a positive electrode active material, the positive electrode active material includes secondary particles, each of the secondary particles includes primary particles, the secondary particles include pored particles each having a pore, a cross section of the positive electrode layer includes a first region and a second region, the first region and the second region are defined as two equal parts formed by dividing the cross section of the positive electrode layer into half in a thickness direction, the first region is interposed between the current-collecting foil sheet and the second region, and a relationship of 50%≤X is satisfied.

### CROSS REFERENCE TO RELATED APPLICATIONS

This nonprovisional application is based on Japanese Patent Application No. 2024-163314 filed on Sep. 20, 2024, with the Japan Patent Office, the entire contents of which are hereby incorporated by reference.

### BACKGROUND

### Field

The present disclosure relates to an electrode, a battery, and a method of producing an electrode.

### Description of the Background Art

International Patent Laying-Open No. WO 2020/261879 discloses that lithium manganese iron phosphate (LMFP) and a high-nickel layered oxide are included as positive electrode active materials and that the average particle size of the secondary particles of the LMFP is from 3 nm to 20 nm.

### SUMMARY

For the purpose of enhancing battery properties, various types of positive electrode active materials have been developed. International Patent Laying-Open No. WO 2020/261879 provides a positive electrode (a battery) with good energy density and good safety, by mixing a high-nickel layered oxide having excellent energy density and LMFP having excellent safety. However, there is still room for improvement in rate properties.

An object of the present disclosure is to improve rate properties.

Hereinafter, the technical configuration and effects of the present disclosure will be described. It should be noted that the action mechanism according to the present disclosure includes presumption. The action mechanism does not limit the technical scope of the present disclosure.
[1] An electrode comprising:
   a current-collecting foil sheet; and
   a positive electrode layer, wherein
   the positive electrode layer is placed on a surface of the current-collecting foil sheet,
   the positive electrode layer includes a positive electrode active material,
   the positive electrode active material includes secondary particles,
   each of the secondary particles includes primary particles,
   the secondary particles include pored particles each having a pore,
   a cross section of the positive electrode layer includes a first region and a second region,
   the first region and the second region are defined as two equal parts formed by dividing the cross section of the positive electrode layer into half in a thickness direction,
   the first region is interposed between the current-collecting foil sheet and the second region, and
   a relationship of 50%≤X is satisfied, where
      X represents a proportion of the pored particles in the first region to the pored particles in both the first region and the second region, and
      X is calculated for the pored particles each having a maximum Feret diameter of 5 μm or more.

The secondary particles include pored particles each having a pore. An electrode that includes pored particles of this type is expected to have improved rate properties as compared to an electrode with relatively high density. Moreover, a cross section of the positive electrode layer includes a first region and a second region. The first region may also be called “a deep portion”, “a deep layer”, and the like. The first region is located closer to the current-collecting foil sheet than the second region is. The second region may also be called “a shallow portion”, “a surface layer”, and the like. When the relationship of 50%≤X is satisfied, electron paths and/or ion paths are formed with high efficiency and thereby rate properties are expected to be improved.
[2] The electrode according to [1], wherein a relationship of 60%≤X is satisfied. When the relationship of 60%≤X is satisfied, rate properties are expected to be further improved.
[3] The electrode according to [1] or [2], wherein
the pored particles include open-pore particles each having the pore open to the outside, and
a relationship of 40%≤Y≤95% is satisfied, where
   Y represents a proportion of the open-pore particles to the pored particles,
   Y is calculated for the pored particles each having a maximum Feret diameter of 5 μm or more.

The pored particles include open-pore particles each having an open pore which is the pore that is open to the outside, as well as closed-pore particles (hollow particles) each having the pore that is not open to the outside. When the electrode has many pores, the electrode active material and the electrolyte can react with each other, and thereby gas can be produced. This phenomenon may occur when closed-pore particles are present in a certain proportion. Therefore, when the relationship of 40%≤Y≤95% is satisfied, the amount of gas production is expected to be reduced.
[4] The electrode according to [3], wherein a relationship of 60%≤Y≤80% is satisfied.

When the relationship of 60%≤Y≤80% is satisfied, the amount of gas production is expected to be further reduced.
[5] The electrode according to any one of [1] to [4], wherein each of the primary particles includes an olivine-type phosphate compound.
[6] The electrode according to [5], wherein the olivine-type phosphate compound is lithium manganese iron phosphate.
[7] A battery comprising the electrode according to any one of [1] to [6].
[8] The battery according to [7], having a bipolar structure.
[9] A method of producing an electrode, the method comprising:
(a) preparing a positive electrode active material;
(b) bringing at least part of the positive electrode active material into contact with a first solvent;
(c) mixing the positive electrode active material after brought into contact with the first solvent, and a second solvent to form a slurry;
(d) applying the slurry to a surface of a current-collecting foil sheet; and
(e) drying the slurry to form a positive electrode layer, wherein
the positive electrode active material includes secondary particles,
the secondary particles include pored particles each having a pore, and
a boiling point of the first solvent is higher than a boiling point of the second solvent.

When the production steps described in [9] above are implemented, the electrode according to [1] above is expected to be produced.
[10] The method of producing an electrode according to [9], wherein in the (c), the positive electrode active material after brought into contact with the first solvent and the positive electrode active material that was not brought into contact with the first solvent are prepared in amounts that satisfy a mass ratio of 1:0 to 1:2, and then mixed with the second solvent.
[11] The method of producing an electrode according to [9] or [10], wherein
the first solvent includes N-methyl-2-pyrrolidone, and
the second solvent includes water.

In the following, an embodiment of the present disclosure (which may be simply called “the present embodiment” hereinafter) and an example of the present disclosure (which may be simply called “the present example” hereinafter) will be described. It should be noted that neither the present embodiment nor the present example limits the technical scope of the present disclosure. The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic cross-sectional view illustrating an electrode according to the present embodiment.

FIG. 2 is a conceptual view illustrating a secondary particle according to the present embodiment.

FIG. 3 is a schematic flowchart illustrating a method of producing an electrode according to the present embodiment.

FIG. 4 is a schematic perspective view illustrating a battery according to the present embodiment.

FIG. 5 is a schematic view of a cross section cut along the line VI-VI in FIG. 4.

FIG. 6 is a table showing conditions for producing positive electrodes in Examples as well as experiment results.

FIG. 7 is a temperature profile during calcination.

### DESCRIPTION OF THE PREFERRED EMBODIMENTS

### Terms and Phrases

Expressions such as “comprise”, “include”, and “have”, and other similar terms are open-ended expressions. In the configuration expressed by an open-ended expression, in addition to an essential component, an additional component may or may not be further included. The expression “consist of” is a closed-end expression. However, even in a configuration that is expressed by a closed-end expression, impurities present under ordinary circumstances as well as an additional element irrelevant to the technique of interest may be included. The expression “consist essentially of” is a semiclosed-end expression. A configuration expressed by a semiclosed-end expression tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in various methods, the order for implementing those things is not limited to the described order, unless otherwise specified. For example, a plurality of steps may proceed simultaneously. For example, a plurality of steps may be implemented in reverse order.

Expressions such as “first” and “second” are used solely for differentiating a plurality of elements from each other. Such expressions do not limit the scope of these elements. For example, these expressions are independent of the order and the significance of these elements.

For example, the expression “at least one of A and B” includes “A or B” and “A and B”. “At least one of A and B” may also be expressed as “A and/or B”.

Any geometric term should not be interpreted solely in its exact meaning. Examples of geometric terms include “parallel”, “vertical”, “orthogonal”, and the like. For example, as long as substantially the same or similar functions are obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A singular form may also include its plural meaning, unless otherwise specified. For example, a particle may mean a plurality of particles, a group of particles, and a powdery and granular material.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤, ≥”. Each of “more than” and “less than” is represented by an inequality symbol without an equality symbol, e.g., “<, ≥”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean±5%, ±3%, ±1%, and/or the like, for example. Each numerical value may be an approximate value that can vary depending on the implementation configuration of the technique of interest. Each numerical value may be expressed in significant figures. Unless otherwise specified, each measured value may be the average value obtained by multiple rounds of measurement. The number of rounds of measurement may be 3 or more, or may be 5 or more, or may be 10 or more. Generally, the greater the number of rounds of measurement is, the more reliable the average value is expected to be. Each measured value may be rounded off based on the number of the significant figures. Each measured value may include an error occurring due to the identification limit of the measurement apparatus, for example.

An apparatus, software, and/or the like used for measurement of various values is merely an example. It is possible to use a product similar to the apparatus and/or the like presented as an example. When a similar product is used, the measurement conditions may be adjusted to be suitable for the apparatus.

The proportion (X) of pored particles in a first region to pored particles in both the first region and a second region as well as the proportion (Y) of open-pore particles to pored particles are measured by the procedure described below. The electrode is cut at a position that is freely selected. Thus, a cross-sectional sample of the positive electrode layer is prepared. The electrode may be either a monopolar electrode (a positive electrode) or a bipolar electrode as long as it includes a positive electrode layer. The cross-sectional sample is subjected to ion milling machining, for example. The cross-sectional sample is examined with a scanning electron microscope (SEM). For example, the magnification for the examination may be adjusted within the range of 5000 to 15000 times (for example, 10000 times). In a plurality of fields of view (for example, in about 5 fields of view), pored particles in both the first region and the second region, pored particles in the first region, and open-pore particles in both the first region and the second region are counted. Among the pored particles and the open-pore particles, those each having a maximum Feret diameter of 5 μm or more are counted. The number of the pored particles in the first region is divided by the number of the pored particles in both the first region and the second region, and thereby “X” is obtained. The number of the open-pore particles in both the first region and the second region is divided by the number of the pored particles in both the first region and the second region, and thereby “Y” is obtained.

The “maximum Feret diameter” of a particle refers to the length of the long side of a circumscribing rectangular (an oblong or a square) that circumscribes the particle. When the circumscribing rectangular is square, the length of the long side refers to the length of a side. The maximum Feret diameter of a secondary particle may be measured in an SEM image mentioned above. The maximum Feret diameter of a primary particle may be measured in a transmission electron microscopy (TEM) image, for example.

“D50” refers to a particle size in volume-based particle size distribution (cumulative distribution) at which the cumulative value reaches 50%. The volume-based particle size distribution is measured with a laser-diffraction particle size distribution analyzer.

A stoichiometric composition formula represents a typical example of a compound. A compound may have a non-stoichiometric composition. For example, “Al₂O₃” is not limited to a compound where the ratio in amount of substance (the molar ratio) is “Al/O=2/3”. “Al₂O₃” represents a compound that includes Al and O in any ratio in amount of substance, unless otherwise specified. For example, the compound may be doped with a trace element. Some of Al and/or O may be replaced by another element.

The chemical composition of a compound may be measured by inductively coupled plasma atomic emission spectroscopy (ICP-AES). A sample (for example, a positive electrode active material) in an amount of 0.1 g is dissolved in a mixed acid (10 ml) of hydrochloric acid and sulfuric acid to prepare a sample solution. The sample solution is diluted to a proper concentration with the use of a volumetric flask. After dilution, composition analysis is carried out with an ICP-AES apparatus. For example, a product under the trade name “PS3520 UVDD II (manufactured by Hitachi High-Tech Science)” and/or the like may be used.

“Derivative” refers to a compound that is derived from its original compound by at least one partial modification selected from the group consisting of functional group introduction, atom replacement, oxidation, reduction, and other chemical reactions. The position of modification may be one position, or may be a plurality of positions. “Substituent” may include at least one selected from the group consisting of alkyl group, alkenyl group, alkynyl group, cycloalkyl group, unsaturated cycloalkyl group, aromatic group, heterocyclic group, halogen atom (F, Cl, Br, I, etc.), OH group, SH group, CN group, SCN group, OCN group, nitro group, alkoxy group, unsaturated alkoxy group, amino group, alkylamino group, dialkylamino group, aryloxy group, acyl group, alkoxycarbonyl group, acyloxy group, aryloxycarbonyl group, acylamino group, alkoxycarbonylamino group, aryloxy carbonylamino group, sulfonylamino group, sulfamoyl group, carbamoyl group, alkylthio group, arylthio group, sulfonyl group, sulfinyl group, ureido group, phosphoramide group, sulfo group, carboxy group, hydroxamic acid group, sulfino group, hydrazino group, imino group, silyl group, and the like, for example. These substituents may be further substituted. When there are two or more substituents, these substituents may be the same as one another or may be different from each other. A plurality of substituents may be bonded together to form a ring.

### <Electrode>

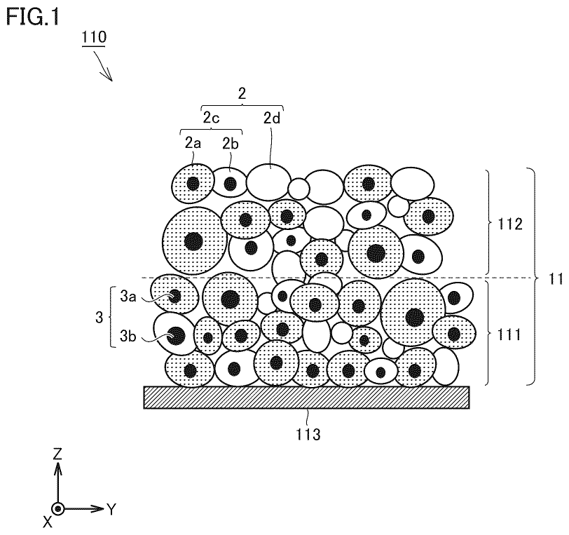

FIG. 1 is a schematic cross-sectional view illustrating an electrode according to the present embodiment. An electrode 110 may be a positive electrode of a monopolar-type battery, for example. The cross section in FIG. 1 is parallel to the thickness direction of electrode 110 (the Z direction). Electrode 110 includes a current-collecting foil sheet 113 and a positive electrode layer 11.

Current-collecting foil sheet 113 is a conductor. Current-collecting foil sheet 113 supports positive electrode layer 11. Current-collecting foil sheet 113 may be in sheet form, for example. The thickness of current-collecting foil sheet 113 may be from 1 to 50 μm, or from 3 to 30 μm, or from 5 to 15 μm, for example. Current-collecting foil sheet 113 is electrically conductive. Current-collecting foil sheet 113 may include a metal foil sheet and/or the like, for example. Current-collecting foil sheet 113 may include at least one selected from the group consisting of Cu, Ni, Zn, Pb, Al, Ti, Fe, Ag, Au, and electrically-conductive resin, for example. Current-collecting foil sheet 113 may include an Al foil sheet, an Al alloy foil sheet, and/or the like, for example. Current-collecting foil sheet 113 may have a multilayer structure, for example. Current-collecting foil sheet 113 may be formed by bonding an Al foil sheet and a Cu foil sheet together, for example.

Positive electrode layer 11 is placed on the surface of current-collecting foil sheet 113. Positive electrode layer 11 may be placed on only one side of current-collecting foil sheet 113. Positive electrode layer 11 may be placed on both sides of current-collecting foil sheet 113. In the case where electrode 110 is a bipolar-type battery, positive electrode layer 11 may be placed on one side (the front side) of current-collecting foil sheet 113 while a negative electrode layer (not illustrated) may be placed on the other side (the back side). For example, a groove may be formed in positive electrode layer 11. Positive electrode layer 11 may be formed in stripes, for example. The thickness of positive electrode layer 11 may be 10 μm or more, or 100 μm or more, or 200 μm or more, or 400 μm or more, or 600 μm or more, or 800 μm or more, or 1 mm or more, for example. The thickness of positive electrode layer 11 may be 1.2 mm or less, or 1 mm or less, or 800 μm or less, for example. In a bipolar structure, positive electrode layer 11 as thick as 200 μm or more may be desirable.

Positive electrode layer 11 includes a positive electrode active material. That is, electrode 110 includes a positive electrode active material.

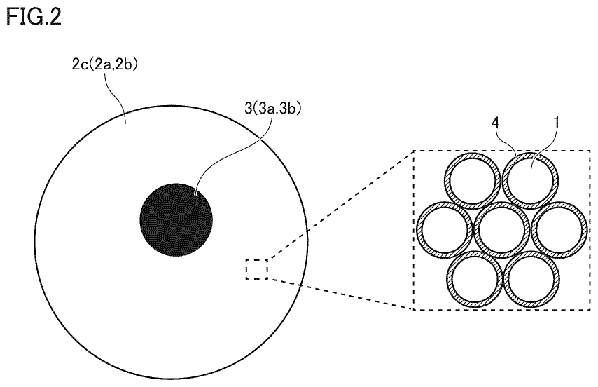

FIG. 2 is a conceptual view illustrating a secondary particle according to the present embodiment. The positive electrode active material includes a plurality of secondary particles 2. Secondary particle 2 is a group of primary particles 1. In other words, secondary particle 2 includes a plurality of primary particles 1. Secondary particles 2 include pored particles 2c each having a pore 3 and non-pored particles 2d not having pore 3. Pored particles 2c include open-pore particles 2a each having an open pore 3a which is pore 3 that is open to the outside, as well as closed-pore particles 2b (hollow particles) each having pore 3 that is not open to the outside. The pore of closed-pore particle 2b is also referred to as a hollow portion 3b. A particle that appears as a non-pored particle 2d in an SEM image may have pore 3 at a position that is invisible in the SEM image. Regardless of this, in the present embodiment, determination of the presence or absence of pore 3 is based solely on the appearance in an SEM image.

The average maximum Feret diameter of 30 secondary particles 2 may be 5 μm or more, or 10 μm or more, or 15 μm or more, or 20 μm or more, for example. The average maximum Feret diameter may be 30 μm or less, or 25 μm or less, or 20 μm or less, or 15 μm or less, or 10 μm or less, for example.

Secondary particle 2 may have a spherical outer shape. When secondary particle 2 is spherical, packing properties are expected to be enhanced, for example. The sphericity of secondary particle 2 may be 0.85 or more, or 0.90 or more, or 0.95 or more. The sphericity of secondary particle 2 may be 1 or less, or 0.95 or less, or 0.90 or less, for example. “Sphericity” refers to the circularity in a surface SEM image (a two-dimensional image). The sphericity (circularity) is determined by the following equation.

$$Ψ = 4 π S / {L}^{2}$$

ψ: Sphericity (circularity)
π: Circular constant
S: Cross-sectional area of secondary particle 2 (the area of a region surrounded by the contour of secondary particle 2)
L: Perimeter of secondary particle 2 (the length of the contour of secondary particle 2)

The sphericity refers to the arithmetic mean of 30 secondary particles 2.

The average maximum Feret diameter of 30 primary particles 1 may be from 10 to 90 nm, for example. That is, the maximum Feret diameter of primary particle 1 may be from 10 to 90 nm, for example. The maximum Feret diameter of primary particle 1 may be 20 nm or more, or 30 nm or more, or 40 nm or more, or 50 nm or more, or 60 nm or more, or 70 nm or more, or 80 nm or more, for example. The maximum Feret diameter of primary particle 1 may be 80 nm or less, or 60 nm or less, for example.

To the surface of primary particle 1, a carbon layer 4 may be adhered. Carbon layer 4 includes carbon (C). The amount of adhered carbon layer 4 in mass fraction relative to secondary particle 2 may be 0.1% or more, or 0.5% or more, or 1% or more, or 2% or more, or 3% or more, or 4% or more, for example. The amount of adhered carbon layer 4 in mass fraction relative to secondary particle 2 may be 5% or less, or 4% or less, or 3% or less, for example.

Each of primary particles 1 may include an olivine-type phosphate compound, a layered-type lithium-metal composite oxide, and/or the like, for example. “Olivine-type” refers to a crystal structure belonging to the space group Pnma. “Layered-type” refers to a crystal structure belonging to the space group R-3m. The space group is identified by X-ray diffraction (XRD) measurement of the powder. Primary particle 1 may be a single-phase compound, for example. Primary particle 1 may further include an amorphous phase and/or the like, for example.

The olivine-type phosphate compound may include lithium iron phosphate (LFP), lithium manganese phosphate (LMP), and/or the like, for example. In LMP, part of manganese (Mn) may be replaced by iron (Fe). Fe-replaced LMP is also called LMFP. LMP may have a composition represented by the following general formula, for example.

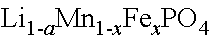

For example, the relationship of −0.5≤a≤0.5 may be satisfied. The Fe-replacing amount (x) may be 0 or more, or 0.05 or more, or 0.1 or more, or 0.2 or more, or 0.3 or more, or 0.4 or more, or 0.5 or more, or 0.6 or more, or 0.7 or more, or 0.8 or more, or 0.9 or more, for example. The Fe-replacing amount (x) may be 0.9 or less, or 0.8 or less, or 0.7 or less, or 0.6 or less, or 0.5 or less, or 0.4 or less, or 0.3 or less, or 0.2 or less, or 0.1 or less, for example.

The LMP may be doped with an element (a dopant) other than lithium (Li), Mn, Fe, phosphorus (P), and oxygen (O). The doping amount (the fraction in amount of substance relative to the amount of substance of Li) may be from 0.01 to 0.1, for example. The dopant may include at least one selected from the group consisting of boron (B), nitrogen (N), a halogen, silicon (Si), sodium (Na), magnesium (Mg), aluminum (Al), chromium (Cr), scandium (Sc), titanium (Ti), vanadium (V), cobalt (Co), nickel (Ni), copper (Cu), zinc (Zn), gallium (Ga), germanium (Ge), selenium (Se), strontium (Sr), yttrium (Y), zirconium (Zr), niobium (Nb), molybdenum (Mo), indium (In), lead (Pb), bismuth (Bi), antimony (Sb), tin (Sn), tungsten (W), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and an actinoid, for example.

The layered-type lithium-metal composite oxide may include lithium-nickel composite oxide (LNO), lithium-cobalt composite oxide (LCO), lithium-manganese composite oxide (LMO), and/or the like, for example.

The LNO may have a composition represented by the following general formula, for example.

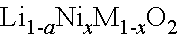

In the formula, the relationships of −0.5≤a≤0.5, 0≤x≤1 are satisfied. M may include, for example, at least one selected from the group consisting of Co, Mn, and Al. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x≤1 may be satisfied. For example, the relationship of −0.4≤a≤0.4, −0.3≤a≤0.3, −0.2≤a≤0.2, or −0.1≤a≤0.1 may be satisfied.

The LNO may include at least one selected from the group consisting of LiNi_{0.9}Co_{0.1}O₂, LiNi_{0.9}Mn_{0.1}O₂, and LiNiO₂, for example.

The LNO may be represented by the following general formula, for example. A compound represented by the following general formula may also be called “NCM”.

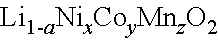

In the formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCM may include at least one selected from the group consisting of LiNi_{1/3}Co_{1/3}Mn_{1/3}O₂, LiNi_{0.4}Co_{0.3}Mn_{0.3}O₂, LiNi_{0.3}Co_{0.4}Mn_{0.3}O₂, LiNi_{0.3}Co_{0.3}Mn_{0.4}O₂, LiNi_{0.5}Co_{0.2}Mn_{0.3}O₂, LiNi_{0.5}CO_{0.3}Mn_{0.2}O₂, LiNi_{0.5}Co_{0.4}Mn_{0.1}O₂, LiNi_{0.8}Co_{0.1}Mn_{0.4}O₂, LiNi_{0.6}Co_{0.2}Mn_{0.2}O₂, LiNi_{0.6}Co_{0.3}Mn_{0.1}O₂, LiNi_{0.6}Co_{0.1}Mn_{0.3}O₂, LiNi_{0.7}Co_{0.1}Mn_{0.2}O₂, LiNi_{0.7}Co_{0.2}Mn_{0.1}O₂, LiNi_{0.8}Co_{0.1}Mn_{0.1}O₂, and LiNi_{0.9}Co_{0.05}Mn_{0.05}O₂, for example.

The LNO may be represented by the following general formula, for example. A compound represented by the following general formula may also be called “NCA”.

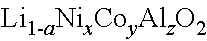

In the formula, the relationships of −0.5≤a≤0.5, 0<x<1, 0<y<1, 0<z<1, x+y+z=1 are satisfied. For example, the relationship of 0<x≤0.1, 0.1≤x≤0.2, 0.2≤x≤0.3, 0.3≤x≤0.4, 0.4≤x≤0.5, 0.5≤x≤0.6, 0.6≤x≤0.7, 0.7≤x≤0.8, 0.8≤x≤0.9, or 0.9≤x<1 may be satisfied. For example, the relationship of 0<y≤0.1, 0.1≤y≤0.2, 0.2≤y≤0.3, 0.3≤y≤0.4, 0.4≤y≤0.5, 0.5≤y≤0.6, 0.6≤y≤0.7, 0.7≤y≤0.8, 0.8≤y≤0.9, or 0.9≤y<1 may be satisfied. For example, the relationship of 0<z≤0.1, 0.1≤z≤0.2, 0.2≤z≤0.3, 0.3≤z≤0.4, 0.4≤z≤0.5, 0.5≤z≤0.6, 0.6≤z≤0.7, 0.7≤z≤0.8, 0.8≤z≤0.9, or 0.9≤z<1 may be satisfied.

NCA may include at least one selected from the group consisting of LiNi_{0.7}Co_{0.1}Al_{0.2}O₂, LiNi_{0.7}Co_{0.2}Al_{0.1}O₂, LiNi_{0.8}Co_{0.1}Al_{0.1}O₂, LiNi_{0.8}Co_{0.17}Al_{0.03}O₂, LiNi_{0.8}Co_{0.15}Al_{0.05}O₂, and LiNi_{0.9}Co_{0.05}Al_{0.05}O₂, for example.

The positive electrode active material may include both an olivine-type phosphate compound and a layered-type lithium-metal composite oxide. The mixing ratio (in mass) between the olivine-type phosphate compound and the layered-type lithium-metal composite oxide may be “(olivine-type phosphate compound)/(layered-type lithium-metal composite oxide)=9/1 to 1/9”, or “(olivine-type phosphate compound)/(layered-type lithium-metal composite oxide)=8/2 to 2/8”, or “(olivine-type phosphate compound)/(layered-type lithium-metal composite oxide)=7/3 to 3/7”, or “(olivine-type phosphate compound)/(layered-type lithium-metal composite oxide)=6/4 to 4/6”, for example.

Positive electrode layer 11 includes a first region 111 and a second region 112. Positive electrode layer 11 may be made of first region 111 and second region 112. Each region may form a layer. First region 111 and second region 112 are defined as two equal parts formed by dividing a cross section of positive electrode layer 11 into half in the thickness direction. In other words, the area fraction of each of first region 111 and second region 112 relative to the entire positive electrode layer 11 is 50%. First region 111 is interposed between current-collecting foil sheet 113 and second region 112. First region 111 is in direct contact with current-collecting foil sheet 113. First region 111 includes the interface between current-collecting foil sheet 113 and positive electrode layer 11. Second region 112 includes the surface of positive electrode layer 11. In other words, second region 112 is exposed at the surface of positive electrode layer 11.

In positive electrode layer 11, the relationship of the following expression is satisfied.

$$50 \% \leq X$$

X represents the proportion of pored particles 2c in first region 111 to pored particles 2c in both first region 111 and second region 112. X is calculated for pored particles 2c each having a maximum Feret diameter of 5 μm or more.

An electrode that includes pored particles 2c is expected to have improved rate properties as compared to an electrode with relatively high density. Moreover, when the relationship of “50%≤X” is satisfied, electron paths and/or ion paths are formed with high efficiency and thereby rate properties are expected to be improved.

X may be 55% or more, or 60% or more, or 65% or more, or 70% or more, or 75% or more. X may be 100% or less, or 95% or less, or 90% or less, or 85% or less, or 80% or less. When the relationship of “60%≤X” is satisfied, rate properties are expected to be further improved.

In positive electrode layer 11, the relationship of the following expression may be satisfied.

$$40 \% \leq Y \leq 95 \%$$

Y represents the proportion of open-pore particles 2a to pored particles 2c. Y is calculated for pored particles 2c each having a maximum Feret diameter of 5 μm or more.

When the electrode has many pores 3, the electrode active material and the electrolyte can react with each other, and thereby gas can be produced. This phenomenon may occur when closed-pore particles are present in a certain proportion. Therefore, when the relationship of 40%≤Y≤95% is satisfied, the amount of gas production is expected to be reduced.

Y may be 45% or more, or 50% or more, or 55% or more, or 60% or more, or 65% or more. Y may be 90% or less, or 85% or less, or 80% or less, or 75% or less, or 70% or less, or 65% or less. When the relationship of “60%≤Y≤80%” is satisfied, the amount of gas production is expected to be further reduced.

Positive electrode layer 11 may further include a conductive material, a binder, a thickening material, and the like, for example, in addition to the positive electrode active material. The amount of the conductive material to be used may be, for example, from 0.1 to 10 parts by mass relative to 100 parts by mass of the positive electrode active material. The conductive material may include any component. The conductive material may include at least one selected from the group consisting of graphite, acetylene black (AB), Ketjenblack (registered trademark), vapor grown carbon fibers (VGCFs), carbon nanotubes (CNTs), and graphene flakes (GFs), for example.

The amount of the binder to be used may be, for example, from 0.1 to 10 parts by mass relative to 100 parts by mass of the positive electrode active material. The binder may include any component. The binder may include at least one selected from the group consisting of polyvinylidene difluoride (PVdF), vinylidene difluoride-hexafluoropropylene copolymer (PVdF-HFP), polytetrafluoroethylene (PTFE), styrene-butadiene rubber (SBR), carboxymethylcellulose (CMC), polyacrylic acid (PAA), polyvinyl alcohol (PVA), polyvinylpyrrolidone (PVP), polyoxyethylene alkyl ether, and derivatives of these, for example. SBR, CMC, PAA, PVP, and the like may also function as a thickening material.

Positive electrode layer 11 may further include an inorganic filler, an organic filler, a solid electrolyte, a surface modifier, a dispersant, a lubricant, a flame retardant, a protective agent, a flux, a coupling agent, an adsorbent, and/or the like, for example. Positive electrode layer 11 may include polyoxyethylene allylphenyl ether phosphate, zeolite, silane coupling agent, MoS₂, WO₃, and/or the like, for example.

### <Method of Producing Electrode>

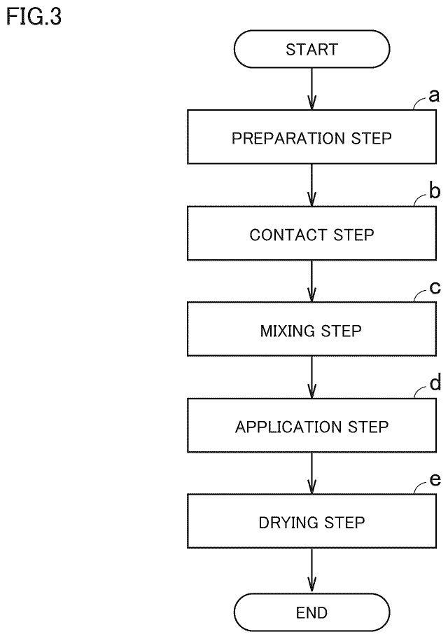

FIG. 3 is a schematic flowchart illustrating a method of producing an electrode according to the present embodiment. Hereinafter, “the method of producing an electrode according to the present embodiment” may be simply called “the present method”. The present method may include “(a) a preparation step”, “(b) a contact step”, “(c) a mixing step”, “(d) an application step”, and “(e) a drying step”, for example.

### (a) Preparation Step

This step involves preparing a positive electrode active material. In the following, a case in which LMFP is produced as a positive electrode active material will be described as an example. However, it should be noted that the positive electrode active material according to the present disclosure is not limited to LMFP.

(a-1) Slurry Formation

This step may include mixing a lithium compound, a manganese compound, an iron compound, a phosphate compound, and a solvent to form a slurry. For example, the lithium compound, the manganese compound, the iron compound, and the phosphate compound may be prepared in amounts that satisfy the composition ratio (in amount of substance) specified in the composition formula “Li₁₋ₐMn₁₋ₓFeₓPO₄ (−0.5≤a≤0.5, 0≤x<1)”. The lithium compound may include lithium hydroxide and/or the like, for example. The manganese compound may include manganese carbonate and/or the like, for example. The iron compound may include ferric phosphate and/or the like, for example. The phosphate compound may include lithium dihydrogen phosphate and/or the like, for example.

When it is intended to form a carbon layer on the surface of each primary particle, a carbon raw material is added to the raw material mixture. The carbon raw material may include a sugar, an organic acid, and/or the like, for example. The carbon raw material may include glucose, sucrose, fructose, citric acid, and/or the like, for example. The amount of the carbon raw material to be added in mass fraction relative to the raw material mixture may be from 1 to 20%, for example.

The solvent may include water and/or the like, for example. The solid concentration of the slurry in mass fraction may be from 20 to 40%, for example. The proportion of secondary particles each having an open pore may be adjusted by changing the solid concentration of the slurry.

Wet grinding may be carried out to adjust the particle size in the slurry. For example, wet grinding may be carried out to achieve a D50 from 0.10 to 1 μm.

(a-2) Granulation

This step may include granulation, namely drying the slurry to produce secondary particles. For example, spray drying may be carried out for granulation to produce secondary particles. The size of the secondary particles as well as the proportion of secondary particles each having an open pore may be adjusted by changing the settings of the spray dryer. The temperature at the air inlet, in particular, may affect the proportion of secondary particles each having an open pore. The temperature at the air inlet may be 190° C. or more, or 210° C. or more, or 230° C. or more, for example. The temperature at the air inlet may be 270° C. or less, or 250° C. or less, for example.

The temperature at the air outlet may be from 100 to 130° C., for example. The spray rate may be from 5 to 15 mL/min, for example. The air intake pressure may be approximately from 1.8 to 2.2 MPa, for example. The nozzle pressure of the spray nozzle may be from 0.1 to 0.3 MPa, for example.

(a-3) Calcination

This step may include performing heat treatment of the secondary particles to produce a positive electrode active material (LMFP). Any heat treatment furnace (such as, for example, an electric furnace, a muffle furnace, and/or the like) may be used. The heat treatment atmosphere may be an inert atmosphere, for example. The inert atmosphere may be a nitrogen atmosphere and/or the like, for example. The heat treatment temperature may be from 400 to 700° C., for example. The heat treatment time may be from 4 to 6 hours, for example. During the temperature-raising process in the calcination, instead of continuously raising the temperature, it is possible to temporarily pause raising the temperature at or near 200° C. and maintain the temperature (200° C.) for about 1 hour.

### (b) Contact Step

This step involves bringing at least part of the positive electrode active material obtained in the preparation step (a), into contact with a first solvent.

The positive electrode active material obtained in the preparation step (a) includes pored particles each having a pore and non-pored particles not having a pore. As a result of the positive electrode active material brought into contact with the first solvent, the pores of the pored particles are filled with the first solvent. Because the pored particles thus filled with the first solvent have greater specific gravity as compared to the non-pored particles, at the time when applied to a current-collecting foil sheet in a step described below, the amount of them present on the current-collecting foil sheet side is expected to be greater.

After brought into contact with the first solvent, the positive electrode active material may be rinsed. As a result, excess first solvent adhered to the surface of the positive electrode active material may be removed. For example, the positive electrode active material after brought into contact with the first solvent may be suction-filtered for solid-liquid separation before rinsed with water.

The first solvent may include N-methyl-2-pyrrolidone (NMP) and/or the like, for example. The duration of contact may be from 6 to 24 hours, for example.

### (c) Mixing Step

This step involves mixing the positive electrode active material after the contact step (b) and a second solvent to form a slurry.

For example, the positive electrode active material after the contact step (b) is dispersed in the second solvent to form a slurry. A conductive material, a binder, and a thickening material may be mixed.

Moreover, the positive electrode active material that was not brought into contact with the first solvent may be mixed. In other words, the positive electrode active material obtained in the preparation step (a) may be mixed in this step, without the contact step (b) implemented. The positive electrode active material after the contact step (b) and the positive electrode active material without the contact step (b) may be prepared in amounts that satisfy a mass ratio in the range of 1:0 to 1:2 and mixed with the second solvent. In the case in which the proportion of the positive electrode active material after the contact step (b) is greater, at the time when applied to a current-collecting foil sheet in a step described below, a greater amount of the positive electrode active material after the contact step (b) is expected to be present on the current-collecting foil sheet side.

The second solvent may include water and/or the like, for example. The boiling point of the first solvent is higher than the boiling point of the second solvent. When the boiling point of the first solvent is higher than the boiling point of the second solvent, at the time of drying in a step described below, the second solvent evaporates faster than the first solvent. As a result, a greater amount of the positive electrode active material filled with the second solvent is expected to become present on the current-collecting foil sheet side. It should be noted that the boiling point of NMP is 202° C. and the boiling point of water is 100° C.

### (d) Application Step

This step involves applying the slurry obtained in the mixing step (c), to the surface of a current-collecting foil sheet.

For example, the slurry may be applied to the surface of a current-collecting foil sheet with the use of a doctor blade, a die coater, and/or the like.

### (e) Drying Step

This step involves drying the slurry after the application step (d), to form a positive electrode layer.

The drying temperature may be 100° C. or more, for example. After drying, the positive electrode layer may be compressed. As a result, the density of the positive electrode layer may be adjusted.

### <Liquid-Type Battery>

In some present embodiments, the battery is a liquid-type battery. The liquid-type battery includes an electrolyte solution. In some present embodiments, the battery has a monopolar structure. In some present embodiments, the battery has a bipolar structure. As an example, a battery having a bipolar structure (a bipolar battery) will be described.

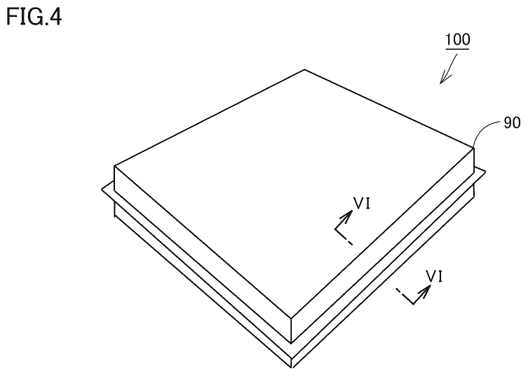

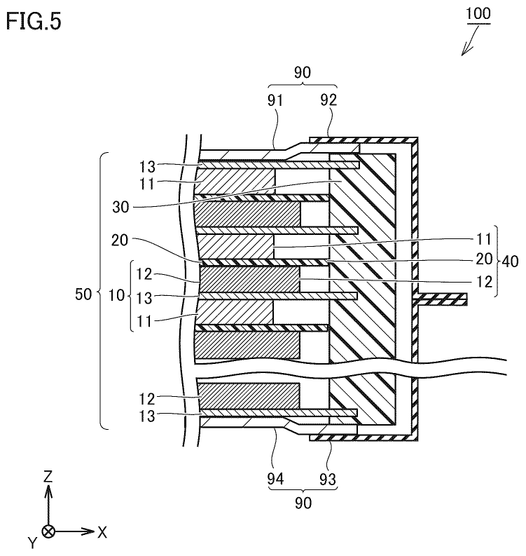

FIG. 4 is a schematic perspective view illustrating a battery according to the present embodiment. FIG. 5 is a schematic view of a cross section cut along the line VI-VI in FIG. 4. Hereinafter, “perpendicular-to-plane direction” refers to the direction of a normal to the surface of a sheet-form member (such as a foil sheet or an electrode, for example). “In-plane direction” refers to any direction that is orthogonal to the perpendicular-to-plane direction. In FIG. 5, the Z-axis direction corresponds to the perpendicular-to-plane direction. Each of the X-axis direction and the Y-axis direction is an example of an in-plane direction.

A battery 100 includes an exterior package 90 and a power generation element 50. Exterior package 90 accommodates power generation element 50. Exterior package 90 may include a first current collector plate 91, a first laminated film 92, a second laminated film 93, and a second current collector plate 94, for example. First laminated film 92 and second laminated film 93 are joined to each other at an end in an in-plane direction. At the joint portion between first laminated film 92 and second laminated film 93, a sealing material (not illustrated) may be interposed between first laminated film 92 and second laminated film 93.

At the ends in the stacking direction (the Z-axis direction), first current collector plate 91 and second current collector plate 94 are joined to power generation element 50, respectively. First laminated film 92 is joined to first current collector plate 91. Second laminated film 93 is joined to second current collector plate 94. At the joint portion between the current collector plate and the laminated film, a sealing material (not illustrated) may be interposed between the current collector plate and the laminated film.

Power generation element 50 includes a plurality of bipolar electrodes 10. Bipolar electrodes 10 are stacked in the perpendicular-to-plane direction (the Z-axis direction). In the perpendicular-to-plane direction, each bipolar electrode 10 includes positive electrode layer 11, a bipolar current-collecting foil sheet 13, and a negative electrode layer 12 in this order. In an in-plane direction (for example, the X-axis direction), bipolar current-collecting foil sheet 13 extends outwardly beyond positive electrode layer 11 and negative electrode layer 12. For example, bipolar current-collecting foil sheet 13 may extend outwardly beyond positive electrode layer 11 and negative electrode layer 12 for the entire periphery in an in-plane direction. The details of positive electrode layer 11 are as described above.

For example, bipolar current-collecting foil sheet 13 may include a metal foil sheet, an electrically-conductive resin layer, and/or the like. For example, bipolar current-collecting foil sheet 13 may be formed by bonding an Al foil sheet and a Cu foil sheet together. A surface of bipolar current-collecting foil sheet 13 may have a carbon material applied thereto. The carbon material may include carbon black and/or the like, for example.

Power generation element 50 includes a sealing material 30. At an end in an in-plane direction, sealing material 30 is attached to current-collecting foil sheet 13. For example, sealing material 30 may be heat-sealed to bipolar current-collecting foil sheet 13. For example, sealing material 30 may be provided along the entire periphery in an in-plane direction. Sealing material 30 may include a resin material and/or the like, for example. Sealing material 30 seals interstices between bipolar current-collecting foil sheets 13 that are adjacent to each other in the perpendicular-to-plane direction. The interstices between bipolar current-collecting foil sheets 13 are thus sealed with sealing material 30, and thereby cells 40 are formed. A cell 40 is the smallest constituent unit of power generation element 50. Because it includes a plurality of cells 40, battery 100 may also be referred to as “a bipolar module”. Each of cells 40 is hermetically sealed. Cells 40 are segregated from each other. Each of cells 40 includes positive electrode layer 11, a separator 20, negative electrode layer 12, and an electrolyte solution.

### (Negative Electrode Layer)

Negative electrode layer 12 is adhered to one side of bipolar current-collecting foil sheet 13. Negative electrode layer 12 is positioned on the opposite side to the side on which positive electrode layer 11 is positioned. The area of negative electrode layer 12 may be greater than that of positive electrode layer 11. Negative electrode layer 12 includes a negative electrode active material.

The negative electrode active material may be in particle form, or may be in sheet form, for example. The D50 of the negative electrode active material may be 1 μm or more, or 5 μm or more, or 10 μm or more, for example. The D50 of the negative electrode active material may be 30 μm or less, or 20 μm or less, or 15 μm or less, or 10 μm or less, for example.

The negative electrode active material may include any component. The negative electrode active material may include at least one selected from the group consisting of carbon-based active material, alloy-based active material, Si—C composite material, Li metal, Li-based alloy, and lithium titanate, for example. In some present embodiments, the battery may be a Li-metal negative electrode battery.

The carbon-based active material may include at least one selected from the group consisting of graphite, soft carbon, and hard carbon, for example. The “graphite” collectively refers to natural graphite and artificial graphite. The graphite may be a mixture of natural graphite and artificial graphite. The mixing ratio (mass ratio) may be “(natural graphite)/(artificial graphite)=1/9 to 9/1”, or “(natural graphite)/(artificial graphite)=2/8 to 8/2”, or “(natural graphite)/(artificial graphite)=3/7 to 7/3”, for example.

The surface of the graphite may be covered with amorphous carbon, for example. The surface of the graphite may be covered with another type of material, for example. This another type of material may include at least one selected from the group consisting of P, W, Al, and O, for example. The another type of material may include at least one selected from the group consisting of Al(OH)₃, AlOOH, Al₂O₃, WO₃, Li₂CO₃, LiHCO₃, and Li₃PO₄, for example.

The alloy-based active material may include at least one selected from the group consisting of Si, Li silicate, SiO, Si-based alloy, tin (Sn), SnO, and Sn-based alloy, for example.

SiO may be represented by the following general formula, for example.

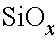

In the formula, the relationship of 0<x<2 is satisfied. For example, the relationship of 0.5≤x≤1.5 or 0.8≤x≤1.2 may be satisfied.

“Si—C composite material” refers to a composite material composed of a carbon-based active material (such as graphite) and an alloy-based active material (such as Si). For example, Si microparticles may be dispersed inside carbon particles. For example, Si microparticles may be dispersed inside graphite particles. For example, Li silicate particles may be covered with a carbon material (such as amorphous carbon).

### (Separator)

Separator 20 is capable of separating positive electrode layer 11 from negative electrode layer 12. Separator 20 is electrically insulating. Separator 20 may include at least one selected from the group consisting of a resin film (a polymer film), an inorganic particle layer, and an organic particle layer, for example. Separator 20 may include a resin film and an inorganic particle layer, for example.

The resin film is porous. The resin film may include a microporous film, a nonwoven fabric, and/or the like, for example. The resin film includes a resin skeleton. The resin skeleton may be continuous in mesh form, for example. Gaps in the resin skeleton form pores. The resin film allows an electrolyte solution to permeate therethrough. The resin film may have an average pore size of 1 μm or less, for example. The resin film may have an average pore size from 0.01 to 1 μm, or from 0.1 to 0.5 μm, for example. “Average pore size” may be measured by mercury porosimetry. The resin film may have a Gurley value from 50 to 250 s/100 cm³, for example. “Gurley value” may be measured by a Gurley test method.

The resin film may include at least one selected from the group consisting of an olefin-based resin, a polyurethane-based resin, a polyamide-based resin, a cellulose-based resin, a polyether-based resin, an acrylic-based resin, a polyester-based resin, and the like, for example. The resin film may include at least one selected from the group consisting of polyethylene (PE), polypropylene (PP), polyamide (PA), polyamide-imide (PAI), polyimide (PI), aromatic polyamide (aramid), polyphenylene ether (PPE), and derivatives of these, for example. The resin film may be formed by stretching, phase separation, and/or the like, for example. The resin film may have a thickness from 5 to 50 μm, or from 10 to 25 μm, for example.

The resin film may have a monolayer structure. The resin film may be made of a PE layer, for example. A skeleton of a PE layer is formed of PE. The PE layer may have shut-down function. The resin film may have a multilayer structure, for example. The resin film may include a PP layer and a PE layer, for example. A skeleton of a PP layer is formed of PP. The resin film may have a three-layer structure, for example. The resin film may be formed by stacking a PP layer, a PE layer, and a PP layer in this order, for example. The thickness of the PE layer may be from 5 to 20 μm, for example. The thickness of the PP layer may be from 3 to 10 μm, for example.

The inorganic particle layer may be formed on the surface of the resin film. The inorganic particle layer may be formed on only one side of the resin film, or may be formed on both sides of the resin film. The inorganic particle layer may be formed on the side facing the positive electrode layer 11, or may be formed on the side facing the negative electrode layer 12. The inorganic particle layer may be formed on the surface of positive electrode layer 11, or may be formed on the surface of negative electrode layer 12.

The inorganic particle layer is porous. The inorganic particle layer includes inorganic particles. The inorganic particles may also be called “an inorganic filler”. Gaps between the inorganic particles form pores. The inorganic particle layer may have a thickness from 0.5 to 10 μm, or from 1 to 5 μm, for example. The inorganic particles may include a heat-resistant material, for example. The inorganic particle layer that includes a heat-resistant material is also called “HRL (Heat Resistance Layer)”. The inorganic particles may include at least one selected from the group consisting of boehmite, alumina, zirconia, titania, magnesia, silica, and the like. The inorganic particles may have any shape. The inorganic particles may be spherical, rod-like, plate-like, fibrous, and/or the like, for example. The inorganic particles may have a D50 from 0.1 to 10 μm, or from 0.5 to 3 μm, for example. The inorganic particle layer may further include a binder. The binder may include at least one selected from the group consisting of an acrylic-based resin, a polyamide-based resin, a fluorine-based resin, an aromatic-polyether-based resin, and a liquid-crystal-polyester-based resin, and the like, for example.

Separator 20 may include an organic particle layer, for example. Separator 20 may include an organic particle layer instead of the resin film, for example. Separator 20 may include an organic particle layer instead of the inorganic particle layer, for example. Separator 20 may include both the resin film and an organic particle layer. Separator 20 may include both the inorganic particle layer and an organic particle layer. Separator 20 may include the resin film, the inorganic particle layer, and an organic particle layer.

The organic particle layer may have a thickness from 0.1 to 50 μm, or from 0.5 to 20 μm, or from 0.5 to 10 μm, or from 1 to 5 μm, for example. The organic particle layer includes organic particles. The organic particles may also be called “an organic filler”. The organic particles may include a heat-resistant material. The organic particles may include at least one selected from the group consisting of PE, PP, PTFE, PI, PAI, PA, aramid, and the like, for example. The organic particles may be spherical, rod-like, plate-like, fibrous, and/or the like, for example. The organic particles may have a D50 from 0.1 to 10 μm, or from 0.5 to 3 μm, for example.

Separator 20 may include a mixed layer, for example. The mixed layer includes both inorganic particles and organic particles.

### (Electrolyte Solution)

The electrolyte solution is a liquid electrolyte. The electrolyte solution includes a solute and a solvent. The concentration of the solute may be from 0.5 to 1 mol/L, or from 1 to 1.5 mol/L, or from 1.5 to 2 mol/L, or from 2 to 2.5 mol/L, or from 2.5 to 3 mol/L, for example. “Mol/L” may also be expressed as “M”. The solute includes a supporting salt (a Li salt). The solute may include an inorganic acid salt, an imide salt, an oxalato complex, a halide, and/or the like, for example. The solute may include at least one selected from the group consisting of LiPF₆, LiBF₄, LiClO₄, LiAsF₆, LiSbF₆, LiN(SO₂F)₂ “LiFSI”, LIN(SO₂CF₃)₂ “LiTFSI”, LiB(C₂O₄)₂ “LiBOB”, LiBF₂ (C₂O₄) “LiDFOB”, LiPF₂ (C₂O₄)₂ “LiDFOP”, LiPO₂F₂, FSO₃Li, LiI, LiBr, and derivatives of these, for example.

The electrolyte solution may include a carbonate-based solvent (a carbonate-ester-based solvent), for example. The solvent may include a cyclic carbonate, a chain carbonate, a fluorinated carbonate, and/or the like, for example. The solvent may include at least one selected from the group consisting of ethylene carbonate (EC), propylene carbonate (PC), butylene carbonate (BC), dimethyl carbonate (DMC), diethyl carbonate (DEC), ethyl methyl carbonate (EMC), monofluoroethylene carbonate (FEC), difluoroethylene carbonate, 4,4-difluoroethylene carbonate, trifluoroethylene carbonate, perfluoroethylene carbonate, fluoropropylene carbonate, difluoropropylene carbonate, and derivatives of these, for example.

The solvent may include a cyclic carbonate (such as EC, PC, FEC) and a chain carbonate (such as EMC, DMC, DEC). The mixing ratio between the cyclic carbonate and the chain carbonate (volume ratio) may be “(cyclic carbonate)/(chain carbonate)=1/9 to 4/6”, or “(cyclic carbonate)/(chain carbonate)=2/8 to 3/7”, or “(cyclic carbonate)/(chain carbonate)=3/7 to 4/6”, for example.

The solvent may include a cyclic carbonate (such as EC, PC) and a fluorinated cyclic carbonate (such as FEC). The mixing ratio between the cyclic carbonate and the fluorinated cyclic carbonate (volume ratio) may be “(cyclic carbonate)/(fluorinated cyclic carbonate)=99/1 to 90/10”, or “(cyclic carbonate)/(fluorinated cyclic carbonate)=9/1 to 1/9”, or “(cyclic carbonate)/(fluorinated cyclic carbonate)=9/1 to 7/3”, or “(cyclic carbonate)/(fluorinated cyclic carbonate)=3/7 to 1/9”, for example.

The solvent may include EC, FEC, EMC, DMC, and DEC, for example. The volume ratio of these components may satisfy the relationship represented by the following equation, for example.

$${V}_{EC} + {V}_{FEC} + {V}_{EMC} + {V}_{DMC} + {V}_{DEC} = 10$$

In the above equation, each of V_{EC}, V_{FEC}, V_{EMC}, V_{DMC}, and V_{DEC} represents the volume ratio of EC, FEC, EMC, DMC, and DEC, respectively.

The relationships of 1≤V_{EC}≤4, 0≤V_{FEC}≤3, V_{EC}+V_{FEC}≤4, 0≤V_{EMC}≤9, 0≤V_{DMC}≤9, 0≤V_{DEC}≤9, 6≤V_{EMC}+V_{DMC}+V_{DEC}≤9 are satisfied.

For example, the relationship of 1≤V_{EC}≤2 or 2≤V_{EC}≤3 may be satisfied.

For example, the relationship of 1≤V_{FEC}≤2 or 2≤V_{FEC}≤4 may be satisfied.

For example, the relationship of 3≤V_{EMC}≤4 or 6≤V_{EMC}≤8 may be satisfied.

For example, the relationship of 3≤V_{DMC}≤4 or 6≤V_{DMC}≤8 may be satisfied.

For example, the relationship of 3≤V_{DEC}≤4 or 6≤V_{DEC}≤8 may be satisfied.

The solvent may have a composition of “EC/EMC-3/7”, “EC/DMC=3/7”, “EC/FEC/DEC=1/2/7”, “EC/DMC/EMC=3/4/3”, “EC/DMC/EMC=3/3/4”, “EC/FEC/DMC/EMC=2/1/4/3”, “EC/FEC/DMC/EMC=1/2/4/3”, “EC/FEC/DMC/EMC=2/1/3/4”, “EC/FEC/DMC/EMC=1/2/3/4” (volume ratio), and/or the like, for example.

The electrolyte solution may include an ether-based solvent. The electrolyte solution may include at least one selected from the group consisting of tetrahydrofuran (THF), 1,4-dioxane (DOX), 1,3-dioxolane (DOL), 1,2-dimethoxyethane (DME), 1,2-diethoxyethane (DEE), hydrofluoroether (HFE), ethylglyme, triglyme, tetraglyme, and derivatives of these, for example.

The electrolyte solution may include any additive. The amount to be added (the mass fraction to the total amount of the electrolyte solution) may be from 0.01 to 5%, or from 0.05 to 3%, or from 0.1 to 1%, for example. The additive may include an SEI (Solid Electrolyte Interphase) formation promoter, an SEI formation inhibitor, a gas generation agent, an overcharging inhibitor, a flame retardant, an antioxidant, an electrode-protecting agent, a surfactant, and/or the like, for example.

The additive may include at least one selected from the group consisting of vinylene carbonate (VC), vinylethylene carbonate (VEC), 1,3-propane sultone (PS), tert-amylbenzene, 1,4-di-tert-butylbenzene, biphenyl (BP), cyclohexylbenzene (CHB), ethylene sulfite (ES), propane sultone (PS), ethylene sulfate (DTD), γ-butyrolactone, phosphazene compound, carboxylate ester [such as methyl formate (MF), methyl acetate (MA), methyl propionate (MP), diethyl malonate (DEM), for example], fluorobenzene (such as monofluorobenzene (FB), 1,2-difluorobenzene, 1,3-difluorobenzene, 1,4-difluorobenzene, 1,2,3-trifluorobenzene, 1,2,4-trifluorobenzene, 1,3,5-trifluorobenzene, 1,2,3,4-tetrafluorobenzene, 1,2,3,5-tetrafluorobenzene, 1,2,4,5-tetrafluorobenzene, pentafluorobenzene, hexafluorobenzene, for example), fluorotoluene (such as 2-fluorotoluene, 3-fluorotoluene, 4-fluorotoluene, 2,3-difluorotoluene, 2,4-difluorotoluene, 2,5-difluorotoluene, 2,6-difluorotoluene, 3,4-difluorotoluene, octafluorotoluene, for example), benzotrifluoride (such as benzotrifluoride, 2-fluorobenzotrifluoride, 3-fluorobenzotrifluoride, 4-fluorobenzotrifluoride, 2-methylbenzotrifluoride, 3-methylbenzotrifluoride, 4-methylbenzotrifluoride, for example), fluoroxylene (such as 3-fluoro-o-xylene, 4-fluoro-o-xylene, 2-fluoro-m-xylene, 5-fluoro-m-xylene, for example), sulfur-containing heterocyclic compound (such as benzothiazole, 2-methylbenzothiazole, tetrathiafulvalene, for example), nitrile compound (such as adiponitrile, succinonitrile, for example), phosphate (such as trimethyl phosphate, triethyl phosphate, for example), carboxylic anhydride (such as acetic anhydride, propionic anhydride, oxalic anhydride, succinic anhydride, maleic anhydride, phthalic anhydride, benzoic anhydride, for example), alcohol (such as methanol, ethanol, n-propyl alcohol, ethylene glycol, diethylene glycol monomethyl ether, for example), and derivatives of these, for example.

The components described above as the solute and the solvent may be used as a trace component (an additive). The additive may include at least one selected from the group consisting of LiBF₄, LiFSI, LiTFSI, LiBOB, LIDFOB, LIDFOP, LiPO₂F₂, FSO₃Li, LiI, LiBr, HFE, DOX, PC, FEC, and derivatives of these, for example.

The electrolyte solution may include an ionic liquid. The ionic liquid may include at least one selected from the group consisting of a sulfonium salt, an ammonium salt, a pyridinium salt, a piperidinium salt, a pyrrolidinium salt, a morpholinium salt, a phosphonium salt, an imidazolium salt, and derivatives of these, for example.

In some present embodiments, the battery may include a gelled electrolyte. In other words, the battery may be a polymer battery. The gelled electrolyte may include an electrolyte solution and a polymer material. The polymer material may form a polymer matrix. The polymer material may include at least one selected from the group consisting of PVdF, PVdF-HFP, polyacrylonitrile (PAN), PVdF-PAN, polyethylene oxide (PEO), polyethylene glycol (PEG), and derivatives of these, for example.

### <All-Solid-State Battery>

In some present embodiments, the battery is an all-solid-state battery. The all-solid-state battery may have a bipolar structure. The all-solid-state battery includes a solid electrolyte instead of the electrolyte solution and separator 20. That is, instead of separator 20, a solid electrolyte layer separates positive electrode layer 11 from negative electrode layer 12. The solid electrolyte layer includes a solid electrolyte and a binder, for example. A solid electrolyte may also be included in positive electrode layer 11 and negative electrode layer 12.

The solid electrolyte may be powder, for example. The D50 of the solid electrolyte may be 0.1 μm or more, or 0.2 μm or more, or 0.3 μm or more, or 0.4 μm or more, or 0.5 μm or more, or 0.6 μm or more, or 0.7 μm or more, or 0.8 μm or more, or 0.9 μm or more, or 1 μm or more, for example. The D50 of the solid electrolyte may be 5 μm or less, or 4 μm or less, or 3 μm or less, or 2 μm or less, or 1 μm or less.

The solid electrolyte may include at least one selected from the group consisting of a sulfide solid electrolyte, a halide solid electrolyte, an oxide solid electrolyte, a hydride solid electrolyte, and a nitride solid electrolyte, for example.

The sulfide solid electrolyte may include at least one selected from the group consisting of an amorphous phase, a crystalline phase, and a glass ceramic (crystallized glass) phase. The crystalline phase may be of argyrodite type, LGPS type, and/or the like, for example. The sulfide solid electrolyte includes Li and sulfur(S). In addition to Li and S, the sulfide solid electrolyte may further include any component.

The sulfide solid electrolyte may include at least one selected from the group consisting of LiI—LiBr—Li₃PS₄, Li₂S—SiS₂, LiI—Li₂S—SiS₂, LiI—Li₂S—P₂S₅, LiI—Li₂O—Li₂S-P₂S₅, LiI—Li₂S—P₂O₅, LiI—Li₃PO₄—P₂S₅, Li₂S—GeS₂—P₂S₅, Li₂S—P₂S₅, Li₁₀GeP₂S₁₂, Li₄P₂S₆, Li₇P₃S₁₁, Li₃PS₄, and Li—PS₆, for example.

For example, “LiI—LiBr—Li₃PS₄” refers to a sulfide solid electrolyte produced by mixing LiI, LiBr, and Li₃PS₄ in a freely-selected ratio in terms of amount of substance. For example, the sulfide solid electrolyte may be produced by a mechanochemical method. The mixing ratio may be expressed with the number placed in front of each raw material. For example, “10LiI-15LiBr-75Li₃PS₄” means that the mixing ratio is “LiI/LiBr/Li₃PS₄=10/15/75 (in amount of substance)”.

The sulfide solid electrolyte may have a composition represented by the following general formula, for example.

$${x Li}_{2} S - ( 1 - x ) {P}_{2} {S}_{5}$$

In the formula, x may be more than 0, or 0.1 or more, or 0.2 or more, or 0.25 or more, or 0.3 or more, or 0.4 or more, or 0.5 or more, or 0.6 or more, or 0.7 or more, or 0.75 or more, or 0.8 or more, or 0.9 or more, for example. x may be 1 or less, or 0.9 or less, or 0.8 or less, or 0.7 or less, or 0.75 or less, or 0.6 or less, or 0.5 or less, or 0.4 or less, or 0.3 or less, or 0.2 or less, or 0.1 or less, for example. For example, when x is 0.75, “xLi₂S-(1-x) P₂S₅” may have a composition of Li₃PS₄.

The sulfide solid electrolyte may have a composition represented by the following general formula, for example.

$$y LiI - z LiBr - ( 100 - y - z ) [ {x Li}_{2} S - ( 1 - x ) {P}_{2} {S}_{5} ]$$

In the formula, x may be 0.5 or more, or 0.6 or more, or 0.7 or more, or 0.75 or more, or 0.8 or more, or 0.9 or more, for example. x may be 1 or less, or 0.9 or less, or 0.8 or less, or 0.75 or less, or 0.7 or less, or 0.6 or less, for example. y may be 0 or more, or 5 or more, or 10 or more, or 15 or more, or 20 or more, or 25 or more, for example. y may be 30 or less, or 25 or less, or 20 or less, or 15 or less, or 10 or less, or 5 or less, for example. z may be 0 or more, or 5 or more, or 10 or more, or 15 or more, or 20 or more, or 25 or more, for example. z may be 30 or less, or 25 or less, or 20 or less, or 15 or less, or 10 or less, or 5 or less, for example.

The sulfide solid electrolyte may have a composition represented by the following general formula, for example.

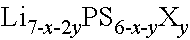

In the formula, relationships of “0<(7-x-2y)”, “0< (6-x-y)”, “0≤x”, and “0≤y” are satisfied. X may include at least one selected from the group consisting of fluorine (F), chlorine (Cl), bromine (Br), and iodine (I), for example.

The sulfide solid electrolyte may have a composition represented by the following general formula, for example.

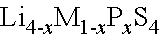

In the formula, x may be more than 0, or 0.1 or more, or 0.2 or more, or 0.3 or more, or 0.4 or more, or 0.5 or more, or 0.6 or more, or 0.7 or more, or 0.8 or more, or 0.9 or more, for example. x may be less than 1, or 0.9 or less, or 0.8 or less, or 0.7 or less, or 0.6 or less, or 0.5 or less, or 0.4 or less, or 0.3 or less, or 0.2 or less, or 0.1 or less, for example. M may include at least one selected from the group consisting of Al, Zn, In, Ge, Si, Sn, Sb, Ga, and Bi, for example.

The sulfide solid electrolyte may have a composition represented by the following general formula, for example.

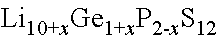

In the formula, x may be 0 or more, or 0.1 or more, or 0.2 or more, or 0.3 or more, or 0.4 or more, or 0.5 or more, or 0.6 or more, for example. x may be 0.7 or less, or 0.6 or less, or 0.5 or less, or 0.4 or less, or 0.3 or less, or 0.2 or less, or 0.1 or less, for example. A sulfide solid electrolyte represented by the above general formula may include an LGPS-type crystalline phase, for example.

The halide solid electrolyte may have a composition represented by the following general formula, for example.

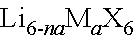

In the formula, n represents an oxidation number of M. For example, M may include an atom whose oxidation number is +3. For example, M may include an atom whose oxidation number is +4. M may include at least one selected from the group consisting of Y, Al, Ti, Zr, Ca, and Mg, for example. The relationship of “0<a<2” may be satisfied, for example. X may include at least one selected from the group consisting of F, Cl, Br, and I, for example.

The halide solid electrolyte may have a composition represented by the following general formula, for example.

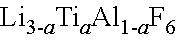

In the formula, a may be 0 or more, or 0.1 or more, or 0.2 or more, or 0.3 or more, or 0.4 or more, or 0.5 or more, or 0.6 or more, or 0.7 or more, or 0.8 or more, or 0.9 or more, for example, a may be 1 or less, or 0.9 or less, or 0.8 or less, or 0.7 or less, or 0.6 or less, or 0.5 or less, or 0.4 or less, or 0.3 or less, or 0.2 or less, or 0.1 or less, for example.

The halide solid electrolyte may have a composition represented by the following general formula, for example.

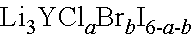

In the formula, the relationship of “0≤(a+b)≤6” may be satisfied, for example, a may be 0 or more, or 1 or more, or 2 or more, or 3 or more, or 4 or more, or 5 or more, for example, a may be 6 or less, or 5 or less, or 4 or less, or 3 or less, or 2 or less, or 1 or less, for example. b may be 0 or more, or 1 or more, or 2 or more, or 3 or more, or 4 or more, or 5 or more, for example. b may be 6 or less, or 5 or less, or 4 or less, or 3 or less, or 2 or less, or 1 or less, for example.

The oxide solid electrolyte may include at least one selected from the group consisting of LiNbO₃, Li_{1.5}Al_{0.5}Ge_{1.5} (PO₄)₃, La_{2/3-x}Li₃ₓ TiO₃, and Li₇La₃Zr₂O₁₂, for example. The hydride solid electrolyte may include LiBH₄ and/or the like, for example. The nitride solid electrolyte may include Li₃N, Li₃BN₂, and/or the like, for example.

### EXAMPLES

### <Production of Positive Electrode>

### (No. 1)

### (a) Preparation Step

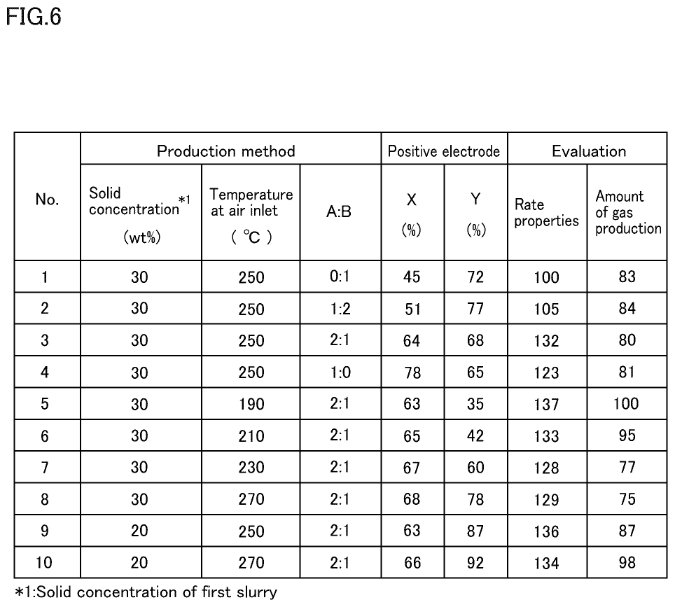

Lithium hydroxide monohydrate, manganese carbonate, ferric phosphate, and lithium dihydrogen phosphate were prepared in amounts that satisfied the composition ratio specified in the composition formula “Li_{1.04}Mn_{0.6}Fe_{0.4}PO₄”. Glucose was prepared in an amount of 8% in mass fraction relative to the total mass of the raw materials. The materials thus prepared and water were mixed together to form a slurry (a first slurry). The solid concentration of the first slurry was as shown in FIG. 6. Wet grinding was carried out to achieve a D50 of 0.30 μm.

The first slurry was spray dried to form secondary particles. The target value of the D50 of the secondary particles was 9±1 μm. The temperature at the air inlet was as specified in FIG. 6. The temperature at the air outlet of the spray dryer was 115±15° C., the spray rate was 10 mL/min, the air intake pressure was 2.0 MPa, and the nozzle pressure of the spray nozzle was 0.2 MPa.

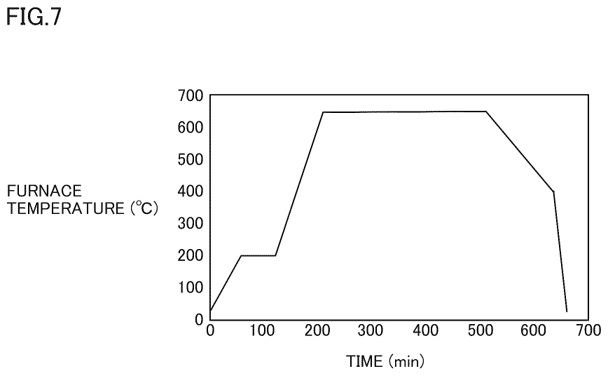

The secondary particles were calcined in a nitrogen atmosphere, and thereby LMFP was synthesized. FIG. 7 is a temperature profile during calcination. Firstly, the furnace temperature is raised at a temperature raising rate of 3° C./minute to reach 200° C. The furnace temperature is maintained at 200° C. for 1 hour. Then, the furnace temperature is raised at a temperature raising rate of 5° C./minute to reach 650° C. The furnace temperature is maintained at 650° C. for 5 hours. Subsequently, the furnace temperature is lowered at a temperature lowering rate of 2° C./minute to reach 400° C. Furthermore, the furnace temperature is lowered at a temperature lowering rate of 15° C./minute to reach room temperature. It should be noted that the contact step (b) was not implemented in No. 1.

### (c) Mixing Step

The LMFP obtained in the above manner, a conductive material (AB), a binder (SBR), and a thickening material (CMC) were mixed together to form a mixture. The mixing ratio (in mass) was “LMFP/(conductive material)/binder/(thickening material)=96/1.5/2/0.5”. The mixture was dispersed in water, and thereby a slurry (a second slurry) was formed.

### (d) Application Step

The second slurry was applied to the surface of an Al foil sheet.

### (e) Drying Step

The second slurry thus applied was dried at 100° C., and thereby a positive electrode layer was formed. The density of the positive electrode layer was adjusted to 1.8 g/cm3 with a roll press, and thereby a positive electrode layer (a positive electrode raw sheet) that included a first region and a second region was formed. The positive electrode raw sheet was vacuum dried at 120° C. for 12 hours.

### (Preparation of Coin Cell)

After drying, the positive electrode raw sheet was die-cut to form a disk-shaped sample (diameter, 14 mm).

Inside a glove box, a coin cell was assembled. The cell configuration is as described below.
Working electrode: Disk-shaped sample (positive electrode)
Counter electrode: Li foil sheet
Separator: Porous polymer film
Electrolyte solution: “EC/DMC=3/7 (in volume)”, LiPF₆ (1 mol/L) (No. 2 to No. 10)

Except that the conditions of the production method were changed as specified in FIG. 6, the same operation as in No. 1 was carried out to produce LMFP.

### (b) Filling Step

Part of the LMFP thus obtained was immersed in NMP for 12 hours. After immersed, suction filtration, solid-liquid separation, and rinsing with water were carried out to remove NMP adhered to the surface of the LMFP.

### (c) Mixing Step

The LMFP thus obtained (NMP-containing LMFP) and LMFP that was not immersed in NMP (no-NMP-containing LMFP) were mixed in the mass ratio, (NMP-containing LMFP):(no-NMP-containing LMFP)=A:B, specified in FIG. 6. These LMFPs were mixed with a conductive material, a binder, and a thickening material in the same proportion as in No. 1 to obtain a mixture. The resulting mixture was dispersed in water, and thereby a second slurry was formed.

Subsequently, the application step (d) and the drying step (e) were implemented in the same manner as in No. 1, and thereby a positive electrode was produced. Then, in the same manner as in No. 1, a coin cell was assembled.

### <Evaluation>

### (Measurement)

X and Y for each No. as shown in FIG. 6 were calculated in the methods described above.

### <Evaluation>

### (Rate Properties)

By the procedure described below, the discharged capacity ratio (1C/0.1C) was measured. It is conceivable that the greater the discharged capacity ratio (1C/0.1C) is, the better the rate properties are.

Based on the discharged capacity (stoichiometric capacity) calculated from the mass of the applied positive electrode layer, the rate corresponding to 1 C is determined. “C” is a symbol denoting a rate of current (an hour rate). At a rate of 1 C, the stoichiometric capacity is charged or discharged in 1 hour. The coin cell is charged by constant current-constant voltage (CCCV) charging under the conditions described below in an environment at a temperature of 25° C.

Rate of CC charging: 0.1 C

Upper limit to charging voltage: 4.3 V

Rate of cut current during CV charging: 0.01 C

After charging, CC discharging is carried out at a rate of 0.1 C to reach 3.0 V, and discharged capacity (0.1 C) (mAh/g) is measured. The coin cell is charged again by the above-described CCCV charging. After charging, CC discharging is carried out at a rate of 1 C to reach 3.0 V, and discharged capacity (1 C) is measured. The discharged capacity (1 C) is divided by the discharged capacity (0.1 C), and thereby the discharged capacity ratio (1C/0.1C) is determined. Results are given in FIG. 6. The values of rate properties in FIG. 6 are relative values relative to the discharged capacity ratio of No. 1, which is defined as 100.

### (Amount of Gas Production)

By the procedure described below, the amount of gas production was measured.

In an environment at a temperature of 60° C., 100 cycles of CC charging and discharging were carried out at a rate of 0.1 C. The conditions of the charging and discharging are as described above. By an Archimedes' method, in an environment at a temperature of 25° C., before the start of the charging and discharging and after 100 cycles, the volume of the coin cell was measured. The volume before the start of the charging and discharging was subtracted from the volume after 100 cycles to determine the amount of gas production. Results are given in FIG. 6. The values of the amount of gas production in FIG. 6 are relative values relative to the amount of gas production in No. 5, which is defined as 100.

### <Results>

As seen in FIG. 6, when the relationship of 50%≤X is satisfied, rate properties tend to be improved. Moreover, when the relationship of 60%≤X is satisfied, rate properties tend to be further improved.

When the relationship of 40%≤Y≤95% is satisfied, the amount of gas production tends to be reduced. Moreover, when the relationship of 60%≤Y≤80% is satisfied, the amount of gas production tends to be further reduced.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. An electrode comprising:
a current-collecting foil sheet; and
a positive electrode layer, wherein
the positive electrode layer is placed on a surface of the current-collecting foil sheet,
the positive electrode layer includes a positive electrode active material,
the positive electrode active material includes secondary particles,
each of the secondary particles includes primary particles,
the secondary particles include pored particles each having a pore,
a cross section of the positive electrode layer includes a first region and a second region,
the first region and the second region are defined as two equal parts formed by dividing the cross section of the positive electrode layer into half in a thickness direction,
the first region is interposed between the current-collecting foil sheet and the second region, and
a relationship of 50%≤X is satisfied, where
X represents a proportion of the pored particles in the first region to the pored particles in both the first region and the second region, and
X is calculated for the pored particles each having a maximum Feret diameter of 5 μm or more.

2. The electrode according to claim 1, wherein a relationship of 60%≤X is satisfied.

3. The electrode according to claim 1, wherein
the pored particles include open-pore particles each having the pore open to the outside, and
a relationship of 40%≤Y≤95% is satisfied, where
Y represents a proportion of the open-pore particles to the pored particles,
Y is calculated for the pored particles each having a maximum Feret diameter of 5 μm or more.

4. The electrode according to claim 3, wherein a relationship of 60%≤Y≤80% is satisfied.

5. The electrode according to claim 1, wherein each of the primary particles includes an olivine-type phosphate compound.

6. The electrode according to claim 5, wherein the olivine-type phosphate compound is lithium manganese iron phosphate.

7. A battery comprising the electrode according to claim 1.

8. The battery according to claim 7, having a bipolar structure.

9. A method of producing an electrode, the method comprising:
(a) preparing a positive electrode active material;
(b) bringing at least part of the positive electrode active material into contact with a first solvent;
(c) mixing the positive electrode active material after brought into contact with the first solvent, and a second solvent to form a slurry;
(d) applying the slurry to a surface of a current-collecting foil sheet; and
(e) drying the slurry to form a positive electrode layer, wherein
the positive electrode active material includes secondary particles,
the secondary particles include pored particles each having a pore, and
a boiling point of the first solvent is higher than a boiling point of the second solvent.

10. The method of producing an electrode according to claim 9, wherein in the (c), the positive electrode active material after brought into contact with the first solvent and the positive electrode active material that was not brought into contact with the first solvent are prepared in amounts that satisfy a mass ratio of 1:0 to 1:2, and then mixed with the second solvent.

11. The method of producing an electrode according to claim 9, wherein
the first solvent includes N-methyl-2-pyrrolidone, and
the second solvent includes water.
